(19) United States
(12) Patent Application Publication
(10) Pub. No.: US 2006/0203896 A1
(43) Pub. Date: Sep. 14, 2006

(54) Semi-digital duplexing

(76) Inventors: Axel Clausen, Munchen (DE); Vladimir Oksman, Morganville, NJ (US)

Correspondence Address: ESCHWEILER & ASSOCIATES, LLC;NATIONAL CITY BANK BUILDING, 629 EUCLID AVE., SUITE 1210, CLEVELAND, OH, 44114, US

(21) Appl. No.: 11/077,636

(22) Filed: Mar. 11, 2005

(51) Int. Cl. H04L 5/16

(52) U.S. Cl. 375/219

(57) ABSTRACT

The inventors have developed a DSL system that can employ digital duplexing for short loops while supporting communications over long loops. For short loops, the system aligns the data symbols at both ends and thereby performs two-way digital duplexing. For longer loops, the system performs semi-digital duplexing: the symbols are aligned for digital duplexing at one end of the loop while echo cancellation is employed at the other end. Over longer loops, the bandwidth for transmissions in one direction may be limited by the complexity of the echo canceller, however, the bandwidth for transmission in the other direction can remain as high as for short loops. Therefore, the system developed by the inventors allows high bandwidth transmission without the loop length limitation associated with conventional VDSL.

### FIELD OF THE INVENTION

The present invention relates generally to communications systems and more particularly to discrete multi-tone (DMT)-based digital subscriber line (DSL) systems and orthogonal frequency division multiplexing (OFDM)-based wireless systems.

### BACKGROUND OF THE INVENTION

Digital subscriber line (DSL) technology provides for transport of high bit-rate digital information over twisted wire pairs, such as telephone lines. Sophisticated digital transmission techniques are required to compensate for inherent deficiencies in lines originally installed to carry only analog voice data. A typical DSL system includes a loop formed by a twisted copper pair connecting a DSL modem (transceiver) at a Customer Premises and another DSL modem at a Central Office, or an intermediate location served by the Central Office through a backbone cable.

DSL modems use various forms of modulation in order to convert digital streams into equivalent analog signals that are suitable for transport along analog transmission lines. Multi-carrier modulation divides an available frequency band into many narrow-band sub-channels. Discrete multi-tone (DMT), a multi-carrier modulation standard, divides the available frequency spectrum into 256 sub-channels. Each sub-channel has its own carrier that is amplitude modulated to convey data.

Data is transmitted in parallel across the sub-channels. Within each sub-channel the data is encoded in terms of an amplitude and phase for a modulation to the sub-channel carrier signal. The amplitude and phase of the modulation is selected from an array of possible values, wherein each array element represents a particular combination of bits. The array of possible values may be referred to as a signal constellation. The number of array elements, which are discrete amplitude phase combinations, that can be consistently distinguished from one-another at the receive end determines the number of bits the sub-channel can carry.

During initialization of communication between the modems, and at times thereafter, the signal-to-noise ratio (SNR) for each sub-channel can be obtained and a maximum bit capacity of each sub-channel determined based thereon. Signal constellations are then assigned to each sub-channel according to their maximum bit capacities. Generally, denser signal constellations representing more bits are assigned to the sub-channels with higher SNRs as compared to sub-channels having lower SNRs. The total number of bits transmitted by the channel is the sum of the bits transmitted by each of the sub-channels. A symbol is a vector having elements corresponding to sub-channel frequencies, each element containing a complex number that gives the amplitude and phase of the modulation for the corresponding frequency.

The data rate is given by the total number of bits per symbol multiplied by the symbol rate. As the data rate is increased and the symbols come closer and closer together in the time domain, inter-symbol interference (ISI) becomes a concern. ISI stems from the non-ideal impulse response of a channel. One method of reducing ISI is to employ a time domain equalizer (TEQ), which shortens the channel impulse response. There is a tradeoff between the degree of channel impulse response shortening and the complexity of a TEQ. Therefore, it is desirable to take further steps to mitigate ISI.

DMT uses a cyclic prefix to reduce ISI. A cyclic prefix is a guard period between symbols and makes the linear convolution of the signal with the channel response appear as a circular convolution. The cyclic prefix is formed by inserting a copy of a group of samples from the end of the symbol, typically the last 1/16^{th}, at the beginning of the symbol. The cyclic prefix is discarded after the symbol is received.

There are various ways of duplexing data: both sending and receiving data over the same channel. A preferred approach is frequency division duplexing. One set of sub-channels is assigned to transmissions in one direction and another set of sub-channels is assigned to transmissions in the other direction. In principle, the transmitted data is orthogonal to the received data. In practice, however, the transmitted data is modulated using an inverse fast Fourier transform (IFFT) that creates side lobes that cause interference. This is an example of near-end echo, in that the symbols being transmitted interfere with the symbols being received on the same channel. A conventional way of addressing near-end echo is with an echo canceller. Echo cancellers work well for moderate bandwidths, but become extremely complicated at very high bandwidths.

With the objective of enabling very high bandwidth DSL (VDSL), digital duplexing, a refinement of frequency division duplexing, has been developed. Digital duplexing involves adding a cyclic suffix, a repetition of a group of samples from the beginning of a DMT symbol, to the end of the symbol. Digital duplexing allows transmitted and received symbols to be temporally aligned, whereby the near end echo is orthogonal to the received symbols after the data is processed through a fast Fourier transform (FFT). Prior art FIG. 1 illustrates the alignment of digital duplexing. At time −6, a remote terminal 1 begins transmitting a symbol 10. The symbol 10 comprises a DMT symbol 11, a cyclic prefix 12, and a cyclic suffix 13. At the same time, the central office 2 begins transmitting a symbol 20, which comprises a DMT symbol 21, a cyclic prefix 22, and a cyclic suffix 23. Symbol 20 begins to arrive at remote terminal 1 while the symbol 10 is still being transmitted. Because symbol 10 has the cyclic suffix 13, the DMT symbol portion 21 of the symbol 20 is received completely at remote terminal 1 while the symbol 10 is still transmitting. After IFFT processing, the DMT symbol 21 will be orthogonal to the near-end echo caused by the symbol 10. Likewise, the DMT symbol 11 is entirely received at the central office 2 while the symbol 21 is still being transmitted.

A limitation of digital duplexing is the channel delay. If the channel delay is longer than the cyclic suffix, then alignment cannot be obtained. Time domain symbol boundaries of transmitted symbols will overlap DMT symbol receptions and the echo data will not be orthogonal to the received data after FFT processing. This situation is illustrated in prior art FIG. 2, wherein the channel delay of 14 μs is greater than the cyclic suffix lengths, which are 8 μs. Transmission of the symbol 10 completes in the midst of receiving the DMT symbol 21 and transmission of the symbol 20 completes in the midst of receiving the DMT symbol 10. This limitation of digital duplexing to shorter channel delays is a major concern because the existing infrastructure has many longer channel delays. As a result, the widespread implementation of VDSL systems has been considered a long way off.

### SUMMARY OF THE INVENTION

One concept of the inventors is directed to systems and methods for data communication wherein, always or selectively, digital duplexing is used at only one of a pair of communicating transceivers. By digital duplexing at only one of a pair of communicating transceivers (semi-digital duplexing), it is meant that at one but only one of the communicating pair, transmitted and received symbols are aligned whereby no boundaries between consecutively transmitted symbols occur while data segments are being received. At the other transceiver where transmitted and received symbols are not aligned, echo cancellation is preferably used. Semi-digital duplexing is preferably used only when the transceivers are communicating over a channel having a relatively long channel delay. Full-digital duplexing is preferably used when the channel delay is relatively short.

The foregoing concept can be employed to extend the reach of very high-speed digital subscriber line (VDSL) systems without a significant penalty in complexity. The system can be installed in facilities having both long and short loops. For loops having short channel delays, full-digital duplexing can be employed and full VDSL service can be provided. Over loops having long delays, very high data rates can still be maintained in at least one direction without using an unreasonably complex echo canceller.

Additional concepts of the inventors relate to transceivers adapted for use in a system according to the foregoing concept. These concepts include transceivers, such as DSL modems, that cooperate to perform semi-digital duplexing. Preferably, the transceivers are adapted to select either semi-digital duplexing of full-digital duplexing based on a channel delay, whereby the equipment can be installed without first determining the channel delay and the equipment can adapt to changes in the channel delay.

Another concept of the inventors uses semi-digital duplexing to ameliorate near-end cross-talk (NEXT) in a bank of transceivers communicating over signal paths having a diversity of channel delays. The transceivers all use the same set of sub-channels for uploads and the same set of sub-channels for downloads. The transceivers each communicate using either semi-digital or full-digital duplexing. Symbol transmissions are timed, whereby all the symbols received at the transceiver bank and all the symbols transmitted from the transceiver bank are time-domain aligned so that no time-domain boundaries between symbols consecutively transmitted from the transceiver bank occur in the midst of receiving data segments from remote locations. Thereby, all the NEXT signals are orthogonal to the data segments after fast Fourier transform (FFT) processing.

The forgoing summary encompasses certain of the inventors' concepts. Its primary purpose is to present these concepts in a simplified form as a prelude to the more detailed description that follows. The summary is not a comprehensive description of what the inventors have invented. Other concepts of the inventors will become apparent to one of ordinary skill in the art from the following detailed description and annexed drawings. Moreover, the detailed description and annexed drawings draw attention to only certain of the inventors' concepts and set forth only certain examples and implementations of what the inventors have invented. Other concepts of the inventors and other examples and implementations of their concepts will become apparent to one of ordinary skill in the art from that which is described and/or illustrated.

### BRIEF DESCRIPTION OF THE DRAWINGS

FIG. 1 is an illustration showing the time-domain alignment of symbols exchanged using digital duplexing according to the prior art.

FIG. 2 is an illustration showing the time-domain misalignment of symbols exchanged across a channel having a substantial delay or latency according to the prior art.

FIG. 3 illustrates an exemplary alignment of symbols for semi-digital duplexing according to one concept of the inventors.

FIG. 4 illustrates an exemplary alignment of symbols with extended cyclic prefixes according to another concept of the inventors.

FIG. 5 is a schematic illustration of a communication system embodying concepts of the inventors.

FIG. 6 illustrates an exemplary alignment of symbols in a modem bank according to another concept of the inventors.

FIG. 7 illustrates another exemplary alignment of symbols in a modem bank according to a further concept of the inventors.

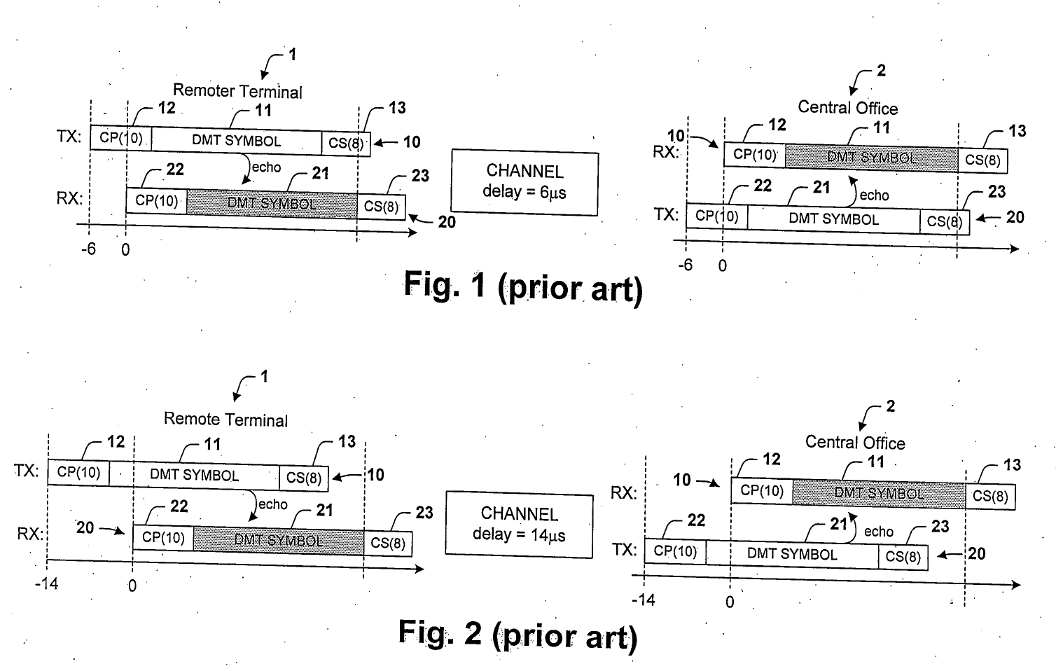

### DETAILED DESCRIPTION OF THE INVENTION

One or more of the inventors' concepts and embodiments thereof will now be described with reference to the attached drawings, wherein like reference numerals are used to refer to like elements throughout. One concept of the inventors relates to communication systems and methods for communicating. According to this concept two transceivers exchange data, represented by symbols, using multiple carriers and frequency division duplexing. Additional duplexing means are employed to combat near-end echo. In particular, semi-digital duplexing is used, by which is meant transmitted and received symbols are aligned at one of the two communicating transceivers. The other transceiver generally uses other duplexing means, typically echo cancellation.

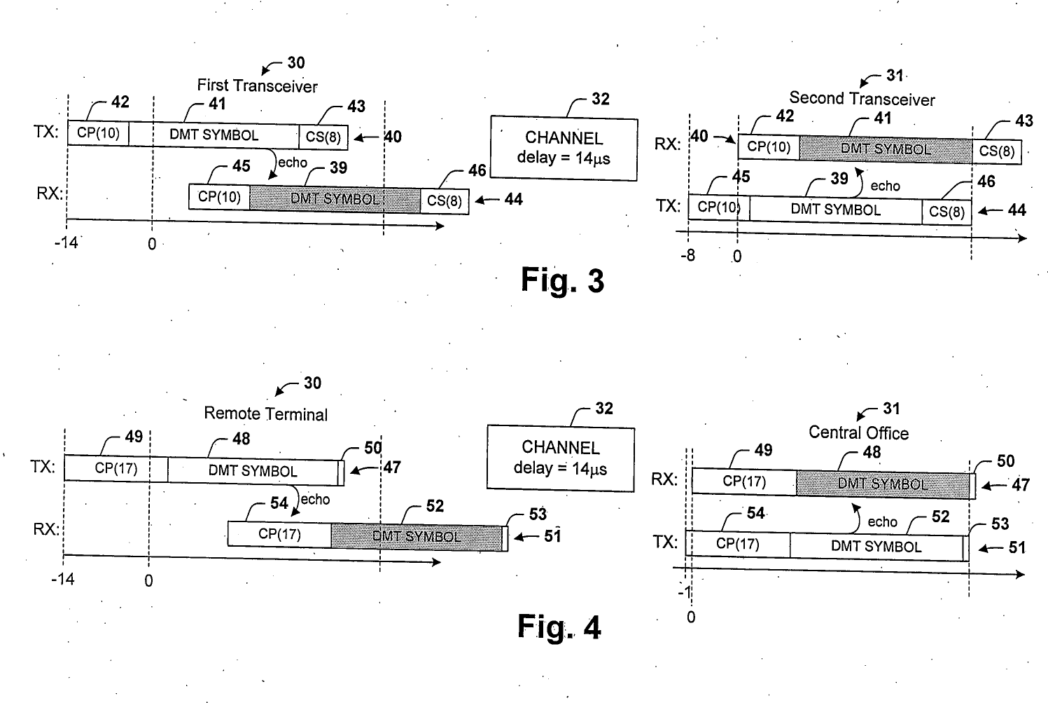

FIG. 3 illustrates the alignment of semi-digital duplexing as conceived by the inventors. A first transceiver 30 and a second transceiver 31 communicate over a channel 32, which has a channel delay or latency of 14 μs. The first transceiver 30 transmits symbols to the second transceiver 31, as exemplified by a symbol 40. The symbol 40 comprises a DMT symbol 41, a cyclic prefix 42, and a cyclic suffix 43. The second transceiver 31 transmits symbols to the first transceiver 30 as exemplified by a symbol 44. The symbol 44 comprises a DMT symbol 39, a cyclic prefix 45, and a cyclic suffix 46. According to the inventors' concept, the symbol 40 is transmitted before the symbol 44. In this example, the symbol 40 begins transmission at t=−14 μs, whereby the symbol 40 begin reception at the second transceiver at t=0. The symbol 44, which is the same length as the symbol 40, begins transmission later, at t=−8 μs, whereby the symbol 40 does not complete transmission before the DMT symbol 41 is completely received at the first transceiver 30. Therefore, the reception of symbol 40 at the second transceiver 31 is not interrupted by a boundary between transmitted symbols. The received and transmitted symbols are aligned at the second transceiver 31 within the meaning of alignment for digital duplexing. This alignment allows the near end echo caused by transmission of the symbol 44, which is at a different frequency from the symbol 40, to be cancelled out during processing of the received DMT symbol 40.

At the first transceiver 30, however, the symbols 40 and 44 are not aligned. The transmission of the symbol 40 is completed and the transmission of a new symbol (not shown) is begun in the midst of receiving the DMT symbol 39; a symbol boundary therefore occurs during reception of the DMT symbol 39. In this example, alignment of symbols at both transceivers is not possible because the channel delay is greater than the lengths of the cyclic suffixes 43 and 46. Because the symbols are not aligned, near-end echo from the symbol 40 cannot be digitally carried out at the first transceiver 30, however, the near-end echo can be, and preferably is, ameliorated by echo cancellation.

A DMT symbol is the portion of a symbol that encodes its data content exclusive of any prefix or suffix. The term data segment is used herein to refer to this portion of a symbol without including limitations from any DMT protocol. A cyclic prefix is an extension of the symbol formed by copying a group of samples from the end of the data segment to the symbol's beginning. The cyclic prefix is used to combat inter-symbol interference (ISI). The longer the cyclic prefix, the better ISI is suppressed

A cyclic suffix is an extension of a symbol formed by copying a group of samples from the beginning of a data segment to the end of the data segment. Cyclic suffixes are provided to facilitate digital duplexing. The longer the cyclic suffixes, the greater the amount of channel delay that can be tolerated in a two-way digital duplexing systems.

When semi-duplexing is used, cyclic suffixes can be made small or dispensed with altogether as illustrated by FIG. 4. FIG. 4 illustrates the first transceiver 30 sending a symbol 47 to the second transceiver 31, and the second transceiver 31 sending a symbol 51 to the first transceiver 30. The symbol 47 comprises a DMT symbol 48, a relatively long cyclic prefix 49, and a relatively short cyclic suffix 50. The symbol 51 comprises a DMT symbol 52, a relatively long cyclic prefix 49, and a relatively short cyclic suffix 53. The total length of the cyclic prefix and the cyclic suffix is the same for the symbols 40, 44, 47, and 51 in FIGS. 3 and 4, yet the cyclic prefixes are longer and inter-symbol interference is better controlled for the symbols in FIG. 4. The difference between the times the symbols 47 and 51 are sent as shown in FIG. 4 is greater than the difference between the times the symbols 40 and 44 are sent as shown in FIG. 3.

The timing used in FIG. 4 allows alignment for digital duplexing to be maintained at the second transceiver 31 with a very short cyclic suffix, ⅛^{th} of the lengths used in FIG. 3. The cyclic suffixes 47 and 53 need only be as long as the near-end echo delay, which is generally very small compared to the channel delay. Under near ideal circumstances, the suffixes can be eliminated entirely. It may also be noted that the individual cyclic suffix and cyclic prefix lengths need not be the same for the transmitted and received symbols.

While the portion of a symbol identified as cyclic suffix and cyclic prefix may be determined in one sense from the way a symbol is constructed, the distribution of the symbol between these portions may be considered differently on reception. For example, suppose a symbol comprises a length M cyclic prefix, a length N data segment, and a length O cyclic suffix. Upon transmit, the first M samples are cyclic prefix, the next N samples are data segment, and the next O samples are cyclic suffix.

On receipt, the data segment may be read 1 sample to the right, whereby the cyclic prefix becomes M+1 samples long, the data segment remains N samples long, and the cyclic suffix becomes O−1 samples long. The data segment retains the same set of samples. The first sample of the data segment is dropped, but the first sample of the cyclic suffix, which is the same, is added. Only the order of the samples in the data segment has changed, but even this makes no difference because the data is treated as a cyclic convolution, whereby taking a sample from the beginning and placing it at the end makes no difference. The extended cyclic prefix is now a copy of the last M+1 samples of the data segment. The shortened cyclic prefix is now a copy of the first O−1 samples of the data segment. For the foregoing reasons, the parts of a symbol considered cyclic prefix, data segment, and cyclic suffix are defined, for purposes of this application, based on the treatment of the symbol upon receipt: the data segment is the portion of the symbol treated as data, the cyclic prefix is the portion of the data treated as cyclic prefix and used to combat ISI, and the cyclic suffix is the portion of the data treated as cyclic suffix.

The inventors' concept is intended for full duplex communications, meaning the communicating transceivers concurrently transmit a series of data symbols, wherein a series of symbols refers to a periodic series with one symbol sent after the other at each of a plurality of carrier frequencies. Preferably, one of the transceivers transmits at a first set of frequencies while the other transmits at a second set of frequencies and the two sets are disjoint, meaning they have no members in common. It is conceivable that there are additional frequencies that might be used by both transceivers to exchange control or other information, but the bulk of the frequencies are assigned to transmissions from one transceiver or the other.

The distribution of frequencies between the two transceivers need not be balanced. The first set of frequencies can be larger or smaller than the second set. If only semi-digital duplexing is used, as opposed to full-digital duplexing it is preferably that lower frequencies be assigned to transmissions from the transceiver at which the symbols are aligned, whereby echo cancellation can be performed at the other end with less complexity.

Preferably, a communication system of the invention can transmit data over a distance of 10,000 feet in one direction at peak rates of at least 10 Mb/s, more preferably at least about 30 Mb/s, and still more preferably at least about 50 Mb/s, in each of the foregoing cases while transmitting data in the other direction using frequency division duplexing, at a rate of at least 0.5 Mb/s.

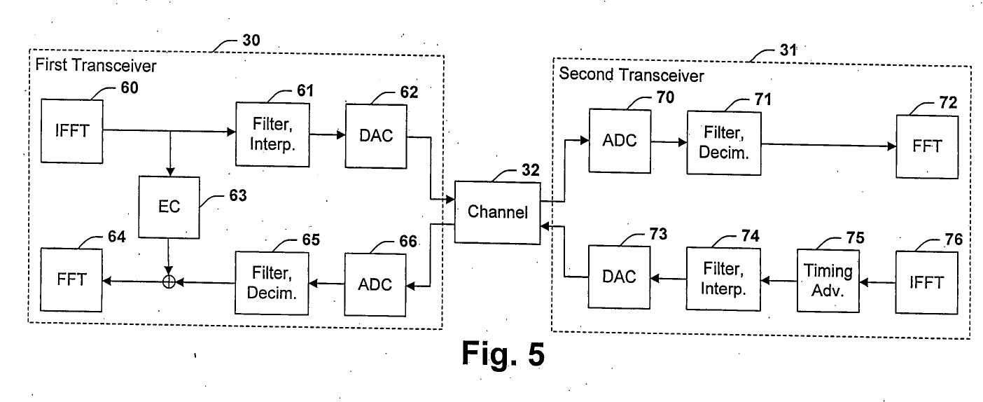

According to the inventors' concept, the transceiver that is not employing digital duplexing is preferably employing echo cancellation. Any suitable approach to echo cancellation can be taken. The echo cancellation can be carried out in the time domain or in the frequency domain, as in cyclic echo synthesis. The echo canceller may have a limited capacity, in the sense that it can only cancel echoes up to a certain frequency in the received signal. FIG. 5 is a schematic illustration showing some details of two exemplary transceivers, which are the first transceiver 30 and the second transceiver 31. For transmissions, the first transceiver 31 is provided with an electronic system 60 for performing an inverse fast Fourier transform (IFFT) on an input data stream, an electronic system 61 for interpolating the digital data from the IFFT 60, and an electronic system 62 for performing digital to analog conversion. These elements cooperate to convert a stream of digital data into analog signals that encode the data and can be transmitted over the channel 32.

For reception, the first receiver 31 comprises an electronic system 66 for performing analog to digital conversion of signals received over the channel 32, an electronic system 65 for smoothing and decimating the digital signals from the ADC 66, an electronic system 63 for canceling the near-end echo signal, and an electronic system 64 for performing a fast Fourier transform on the echo-canceled data. The resulting received data stream can be provided to a host system (not shown). The first transceiver 31 may be configured to make use of the echo canceller 63 selectively, whereby the echo canceller 63 can be turned off when the received data is aligned for digital duplexing.

For reception, the second transceiver 31 comprises an electronic system 70 for performing analog to digital conversion, an electronic system 71 for performing smoothing and decimating the received data, and an electronic system 72 for performing a fast Fourier transform on the decimated data. Near-end echo is carried by the received symbols, but is orthogonal to the data after processing by the FFT 72. An echo canceller is not required at the second transceiver, although one may be provided to allow the transceiver 31 to selectively function like the transceiver 30.

For transmission, the second transceiver 31 comprises an electronic system 76 for performing an IFFT on an input data stream, an electronic system 75 for controlling the timing of the symbol transmission to achieve the alignment required for digital duplexing at the transceiver 31, an electronic system 74 for interpolating the digital data, and an electronic system 73 for converting the data into an analog symbol. In this example, the timing required for semi-digital duplexing is accomplished through the timing advance component 75 at the second transceiver 31, but in general the time difference between when the two transceivers send their symbols can be controlled by either transceiver.

An electronic system can comprise any combination of electrical components configured or configurable by software and/or firmware to perform the intended function. Electronic components include hardware. Examples of hardware include logic devices, analog circuits, and electrical connectors.

The transceiver 30 and 31 can be DSL modems having suitable circuitry for providing DSL communication service on the channel 32. DSL modems generally operate in accordance with ANSI T1.413 (ADSL), T1.424 (VDSL) and other DSL standards. Either of the transceiver 31 and 32 may comprise an application interface to a host system, such as a service subscriber's home computer. Either of the transceiver 31 and 32 may comprise an application interface to a network node.

The channel 32 can be, for example, a twisted pair or copper wires in a conventional residential telephone system, although a system according to the inventors' concept may be employed in communication systems having any type of communication channel by which data can be transferred between the transceivers 30 and 31.

Although the inventors' concepts are described herein primarily with reference to DSL systems, it should be understood that these concepts may be employed in conjunction with any type of frequency division duplexed multi-carrier communication system, and all such system are contemplated as falling within the scope of the claims except to the extent that particular claims have explicit limitation restricting them to certain classes of communication systems. For example, the inventors' concepts are applicable to wireless communication systems employing orthogonal frequency division multiplexing (OFDM).

Reference is made herein to the selective use of semi-digital duplexing with echo cancellation or full-digital duplexing. Such a selection is generally made based on channel delay. If the channel delay is too high for full-digital duplexing, than semi-digital duplexing with echo cancellation at one end is selected. If the channel delay is low enough to make full-digital duplexing practical, than full-digital duplexing is generally employed. One approach is to set a maximum length for the cyclic suffix. If the channel delay exceeds that maximum, then semi-digital duplexing is selected.

An incidental advantage generally seen with the inventors' concept is that circumstances under which echo cancellation is typically employed are also circumstances in which the channel bandwidth is generally relatively lower. Longer channels tend to have higher SNRs. With higher SNRs, fewer frequencies can be used and echo cancellation is naturally less complex. Another incidental advantage generally seen with the inventors' concept is that longer cyclic prefixes can be used when duplexing is only semi-digital. The circumstances under semi-digital duplexing is typically employed are also circumstances in which the channel's impulse response is more dispersed and ISI is greater. The ability to use longer cyclic prefixes simplifies the requirements for any time domain equalizers used by the transceivers.

A further concept of the inventors relates to mitigating near-end crosstalk (NEXT) in a bank of transceivers communicating in full duplex mode with frequency division duplexing. A bank of transceivers is a group of transceivers at one location, such as a group of DSL modems in a street cabinet housing a Digital Subscriber Line Access Multiplexer (DSLAM). According to this concept, all the modems use the same division between transmission and reception frequencies and the symbols among all the modems are aligned whereby NEXT is orthogonal to the received data and is separated therefrom by FFT processing.

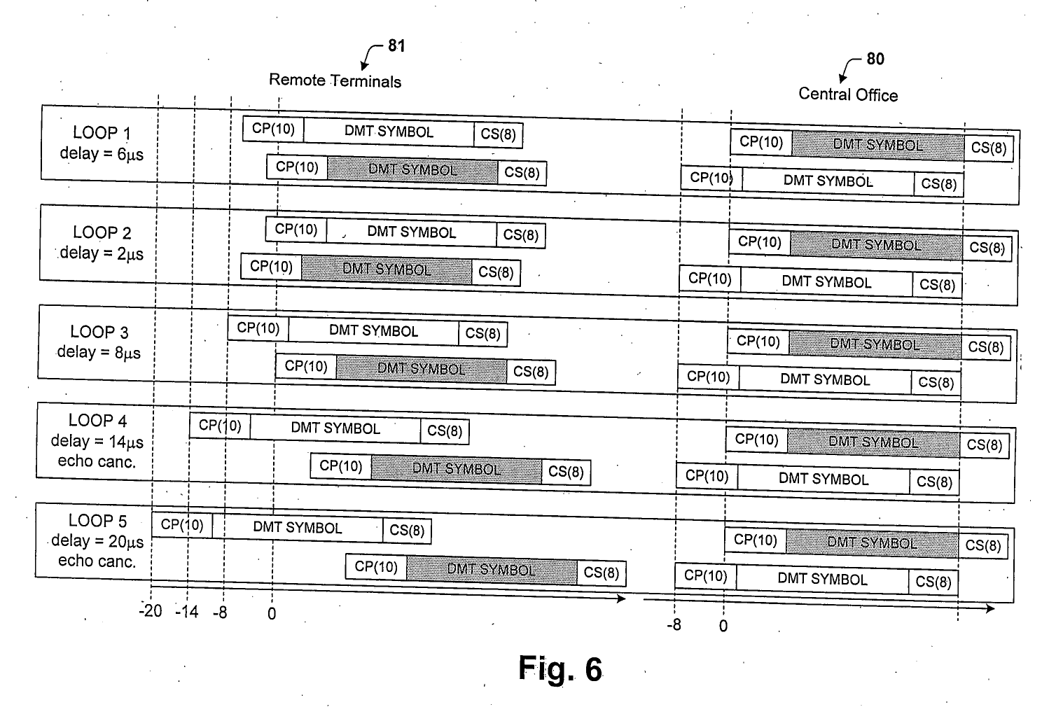

FIG. 6 illustrates this concept with a bank of modems at a central office 80 communicating with modems at remote terminals 81 over loops having varying lengths. For the three shortest loops, the symbols are aligned at both the central office 80 and the remote terminals 81 and full-digital duplexing can be employed. For the two longest loops, full-digital duplexing cannot be employed. Instead, semi-digital duplexing is performed with digital duplexing at the central office 80. As can be seen from FIG. 6, all the transmitted and received symbols are aligned at the central office 80 and near-end echo and NEXT can be digitally cancelled out.

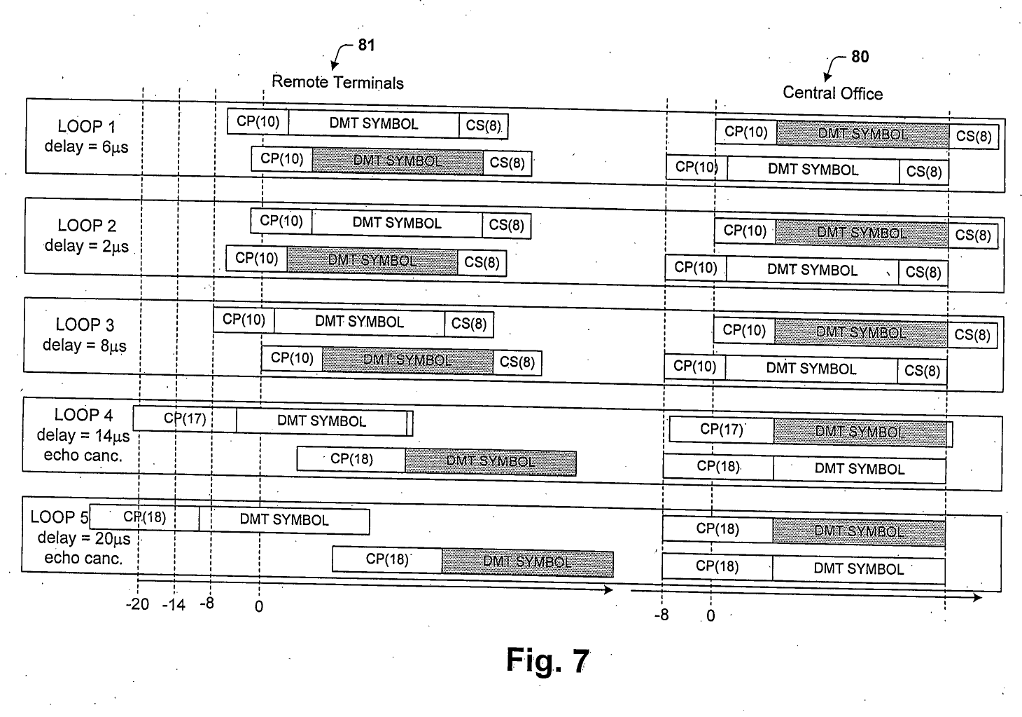

FIG. 7 illustrates another example of this concept. In FIG. 7, longer cyclic prefixes are used for loops that employ semi-digital duplexing, as opposed to full-digital duplexing. The symbol timings vary slightly at the central office 80 among the various modems, however, the symbols are still all aligned within the meaning of alignment in the context of digital duplexing. LOOP 5 provides an example where cyclic suffixes are dispensed with altogether. LOOP 4 provides an example where the cyclic prefix lengths are different for the upload and download directions. LOOP 4 also illustrates how the cyclic suffix can be eliminated for symbols traveling in one direction while being maintained for symbols traveling in the other direction.

The invention as delineated by the following claims has been shown and/or described in terms of certain concepts, aspects, embodiments, and examples. While a particular feature of the invention may have been disclosed with respect to only one of several concepts, aspects, examples, or embodiments, the feature may be combined with one or more other concepts aspects, examples, or embodiments where such combination would be recognized as advantageous by one of ordinary skill in the art. Also, this one specification may describe more than one invention and the following claims do not necessarily encompass every concept, aspect, embodiment, or example described herein.

What is claimed is:

1. A communication system, comprising:
a first transceiver configured to transmit data as a series of symbols; and
a second transceiver configured to transmit data as a series of symbols;
wherein the symbols each comprise a data segment;
the first and second transceivers are configured to use frequency division duplexing; and
the second transceiver is configured to receive symbols from the first transceiver;
the second transceiver is configured to transmit symbols to the first transceiver;
the first and second transceivers are configured to always or selectively time the symbol transmissions whereby, at the second transceiver, symbol transmissions overlap symbol receptions, but time-domain boundaries between consecutive symbol transmissions do not occur while data segments of symbols are being received; and
the first receiver is configured to selectively or always use echo cancellation.

2. The communication system of claim 1, wherein the first receiver comprises an echo canceller operative up to a first bandwidth, but the system is capable of effective frequency division duplexed communication up to a second bandwidth that is much higher than the first bandwidth.

3. The communications system of claim 1, wherein the first transceiver is configured to use echo cancellation when a delay of a channel between the first and second transceivers is relatively higher, but not when the delay is relatively lower.

4. The communications system of claim 3, wherein:
the symbols transmitted from the first transceiver to the second transceiver comprise cyclic prefixes and the system is configured to use cyclic prefixes that are effectively longer when the echo cancellation is in use than when the echo cancellation is not in use.

5. The communications system of claim 1, wherein the first and second transceivers are further configured to always or selectively time the symbol transmissions whereby, at the first transceiver, symbol transmissions overlap symbol receptions, but time-domain boundaries between consecutive symbol transmissions do not occur while data segments of symbols are being received.

6. A DSL system comprising the communication system of claim 1.

7. A wireless communication system comprising the communication system of claim 1.

8. A method of communicating between a first and a second transceiver in full duplex mode, comprising:
transmitting a series of data symbols from the first transceiver to the second transceiver at a first set of frequencies; and
transmitting a series of data symbols from the second transceiver to the first transceiver at a second set of frequencies, the first set of frequencies and the second set of frequencies being disjoint sets;
using echo cancellation at the first transceiver to process data received there from the second transceiver;
wherein the symbols each comprise a data segment; and
the symbol transmissions are timed whereby the second transceiver transmits portions of symbols to the first transceiver while simultaneously receiving portions of symbols from the first transceiver, but the second transceiver neither completes any current symbol transmission or begins any new symbol transmission in the midst of receiving data segments from the first transceiver.

9. The method of claim 8, wherein the second set of frequencies has a greater number of members than the first set of frequencies.

10. The method of claim 8, wherein the frequency bands having higher SNR are preferentially assigned to the first set of frequencies, whereby the average bandwidth with per frequency with which the first transceiver transmits is greater than the average bandwidth with per frequency with which the second transceiver transmits.

11. A method of communicating between a first and a second transceiver in full duplex mode, comprising:
determining a channel delay between the first and the second transceivers; and
communicating between the first and second transceivers according to the method of claim 8 if the channel delay is above a critical value; and
communicating between the first and second transceivers without using echo cancellation if the channel delay is below the critical value.

12. The method of claim 11, wherein the transceivers communicate with symbols comprising cyclic suffixes at channel delays below the critical value, but communicate with shorter cyclic suffixes or dispense with cyclic suffixes at channel delays above the critical value.

13. The method of claim 11, wherein the transceivers communicate with symbols comprising cyclic prefixes at channel delays both above and below the critical value, but longer cyclic prefixes are use for higher channel delays.

14. A DSL system operative according to the method of claim 8.

15. A wireless communication system operative according to the method of claim 8.

16. A method, comprising:
communicating between two ends of a DSL loop using frequency division duplexing;
wherein the communication employs digital duplexing, but not echo cancellation, to combat near-end echo at one end of the DSL loop while employing echo cancellation to near-end echo at the other end of the DSL loop.

17. A method of communicating between DSL modems, comprising:
determining a channel delay between the two modems;
based on the channel delay, communicating either according to the method of claim 16, or communicating employing digital duplexing at both modems.

18. A method of mitigating NEXT among a bank of transceivers at one location communicating with transceivers at a plurality of remote locations over channels have a diversity of channel delays:
communicating between the transceivers in the bank and the transceivers at the remote locations using frequency division duplexing, wherein the communication involves sending symbols in both upload and download directions and the symbols each comprise a data segment;
using full-digital duplexing for the communications between transceivers in the bank and a subset of the transceivers at the remote locations, wherein the full-digital duplexing comprises providing the symbols with suffixes added to the data segments; and
timing the symbol transmissions from the transceivers in the bank and the symbol transmissions from the remote locations, whereby all the symbols received at the transceiver bank and all the symbols transmitted from the transceiver bank are time-domain aligned so that no time-domain boundaries between symbols consecutively transmitted from the transceiver bank occur in the midst of receiving any data segments from the remote locations at the transceiver bank;
wherein some of the symbols received at the transceiver bank from the remote locations travel over channels having channel delays greater than the lengths of the suffixes.

19. The method of claim 18, wherein the transceivers at the remote location that communicate with the transceiver bank over channels having channel delays greater than the lengths of the suffixes use echo cancellation.

20. The method of claim 18, wherein;
the transceivers in the bank transmit symbols at a first set of frequencies;
the transceivers at the remote locations transmit symbols at second set of frequencies; and
the first and second sets are disjoint.

21. A transceiver, comprising:
an electronic system for negotiating with a remote transceiver to determine signal constellations to use for each of a plurality of sub-channels;
an electronic system for receiving a digital data stream and converting it into a symbol representation selected from the signal constellations;
an electronic system for converting the symbol representation into an outgoing analog signal for transmission to the remote transceiver;
an electronic system for receiving an incoming analog signal and converting it into a received symbol representation; and
an electronic system for converting the received symbol representation into a digital data stream;
wherein the transceiver is configured to cooperate with the remote transceiver to align the incoming and outgoing signals for digital duplexing at the transceiver under circumstances where the remote transceiver is too far away to perform two-way digital duplexing without extending a signal length.

22. The transceiver of claim 21, wherein the transceiver is further configured to perform two-way digital duplexing with remote transceivers that are near enough.

23. The transceiver of claim 22, wherein the transceiver is configured to communicate with the remote transceiver to determine whether digital duplexing will be two-way or one-way.

24. A transceiver, comprising:
an electronic system for negotiating with a remote transceiver to determine signal constellations to use for each of a plurality of sub-channels;
an electronic system for receiving a digital data stream and converting it into a representation formed by symbols selected from the signal constellations;
an electronic system for converting the symbol representation into an outgoing analog signal for transmission to the remote transceiver;
an electronic system for receiving an incoming analog signal and converting it into a received symbol representation;
an electronic system for converting the received symbol representation into a digital data stream; and
an electronic system for performing echo cancellation
wherein the transceiver is configured to cooperate with the remote transceiver to align the outgoing and incoming signals for digital duplexing at the remote transceiver under circumstances where the remote transceiver is too far away to perform two-way digital duplexing without extending a signal length.

25. The transceiver of claim 24, wherein the transceiver is further configured to perform two-way digital duplexing with remote transceivers that are near enough.

26. The transceiver of claim 25, wherein the transceiver is configured to communicate with the remote transceiver to determine whether digital duplexing will be two-way or one-way.

27. The communications system of claim 1, wherein the system is configured to evaluate the delay of the channel during a training phase.
